(19) United States
(12) Patent Application Publication
(10) Pub. No.: US 2019/0044730 A1
(43) Pub. Date: Feb. 7, 2019

(54) APPARATUS AND METHOD FOR GENERATING AND OPERATING DYNAMIC CAN ID BASED ON HASH-BASED MESSAGE AUTHENTICATION CODE

(71) Applicant: ELECTRONICS AND TELECOMMUNICATIONS RESEARCH INSTITUTE, Daejeon (KR)

(72) Inventors: Samuel WOO, Daejeon (KR); Dae-Sung MOON, Daejeon (KR); Kyung-Min PARK, Daejeon (KR); Jooyoung LEE, Daejeon (KR); IK-KYUN KIM, Daejeon (KR); Seung-Hun JIN, Daejeon (KR); Ho HWANG, Daegu (KR)

(73) Assignee: ELECTRONICS AND TELECOMMUNICATIONS RESEARCH INSTITUTE, Daejeon (KR)

(21) Appl. No.: 15/994,049

(22) Filed: May 31, 2018

(30) Foreign Application Priority Data
Aug. 2, 2017 (KR) 10-2017-0098153

(51) Int. Cl. H04L 9/32; H04L 29/06

(52) U.S. Cl. CPC H04L 9/3242; H04L 2012/40215; H04L 63/0435; H04L 9/3228

(57) ABSTRACT

Disclosed herein are an apparatus and method for generating and operating a dynamic Controller Area Network (CAN) Identifier (ID). The apparatus includes a priority ID generation unit for generating a priority ID that is a base ID, a dynamic ID generation unit for generating a dynamic ID that is dynamically changed, and a communication unit for transmitting/receiving a data frame in which a dynamic CAN ID including the priority ID and the dynamic ID is combined with data.

### CROSS REFERENCE TO RELATED APPLICATION

This application claims the benefit of Korean Patent Application No. 10-2017-0098153, filed Aug. 2, 2017, which is hereby incorporated by reference in its entirety into this application.

### BACKGROUND OF THE INVENTION

### 1. Technical Field

The present invention relates generally to active defensive technology for incapacitating vulnerability analysis and forced control attacks that are made on a network within a transport means, and more particularly, to technology for increasing expenses required for making attacks by dynamically changing fixed Controller Area Network (CAN) Identifiers (IDs) used by Electronic Control Units (ECUs) mounted in a transport means.

### 2. Description of the Related Art

With the development of convergence of the automobile and information-and-communication technologies, various ECUs have come to be mounted in vehicles. With an increase in the number of ECUs mounted in a vehicle, the complexity of an in-vehicle network is greatly increased. Accordingly, Bosch has developed a Controller Area Network (CAN) to construct an efficient in-vehicle network. Since an in-vehicle network was in a greatly closed environment at the time at which a CAN was developed, an information protection function was not applied at the time of design of the CAN.

Recently, as a connected-car service in which a vehicle is always connected to the Internet has been commercialized, various types of cyber attacks have been made on vehicles. Research into forced control attacks on vehicles published since 2010 has pointed out that the fundamental cause of vehicle hacking is the lack of an authentication function including data frame authentication, ECU authentication, etc. in a CAN.

For last 10 years, a lot of research into solutions to authentication problems in a CAN has been published, but the security technologies proposed in existing research have the following limitations.

First, since the size of a CAN data payload is excessively small, a Message Authentication Code (MAC) having a sufficiently secure size cannot be used. There is thus a tradeoff between security and availability.

Second, when an additional data frame is transmitted to use MAC, an authentication delay occurs and a bus load increases.

Third, a security protocol for transmitting a MAC using a Cyclic Redundancy Check (CRC) field or an extended ID field cannot be applied to a standard CAN. That is, the security protocol can be used only when a new type of CAN protocol is developed.

Fourth, due to the limited characteristics of the CAN, data frame authentication technology that supports real-time data processing cannot be used.

Although authentication technology in which a compromise is struck between security and availability can be applied to a CAN, an attacker can easily bypass an authentication function when a static security policy is used. In particular, truncated MAC usage schemes proposed in most existing research are very vulnerable to collision attacks.

Because of this, vehicle manufacturers have not yet completely solved the authentication problem of a CAN. Unless the fundamental vulnerabilities of a CAN are solved, more vehicle hacking cases will occur in the future.

The above-described background technology is technological information that was possessed by the present applicant to devise the present invention or that was acquired by the present applicant during the course of devising the present invention, and thus such information cannot be construed to be known technology that was open to the public before the filing of the present invention. In connection with this, Korean Patent No. 10-1748080 disclosese a technology related to “System and method for transmitting and receiving data based on CAN-BUS for marine IOT platform.”

### SUMMARY OF THE INVENTION

Accordingly, the present invention has been made keeping in mind the above problems occurring in the prior art, and an object of the present invention is to provide an apparatus and method for dynamically generating and operating CAN IDs used by ECUs mounted in a transport means (e.g. a vehicle).

Another object of the present invention is to provide an apparatus and method for generating and synchronizing dynamic CAN IDs using a Hash-based Message Authentication Code (HMAC).

In accordance with an aspect of the present invention to accomplish the above objects, there is provided an apparatus for generating and operating a dynamic Controller Area Network (CAN) identifier (ID), including a priority ID generation unit for generating a priority ID that is a base ID; a dynamic ID generation unit for generating a dynamic ID that is dynamically changed; and a communication unit for transmitting/receiving a data frame in which a dynamic CAN ID including the priority ID and the dynamic ID is combined with data.

The apparatus may further include a dynamic ID verification unit for, when a data frame is received from an additional device, generating a verification dynamic ID using a method identical to that of the dynamic ID, and verifying a dynamic ID included in the received data frame using the verification dynamic ID.

The priority ID may be maintained at a fixed value rather than being dynamically changed.

The priority ID generation unit may generate a priority ID to which a number of bits sufficient to represent a total number of devices belonging to an identical sub-network are allocated.

The priority ID may not overlap priority IDs corresponding to additional devices belonging to the identical sub-network.

The dynamic ID generation unit may generate the dynamic ID such that a sum of a number of bits of the dynamic ID and a number of bits of the priority ID becomes a preset number of bits of a CAN ID.

The apparatus may further include a one-time key generation unit for generating a one-time key required to generate a hash value to be used in a Hash-based Message Authentication Code (HMAC), wherein the dynamic ID generation unit may be configured to generate the dynamic ID using the one-time key.

The one-time key generation unit may generate a new one-time key using one or more of previously generated one-time keys.

The dynamic ID verification unit may verify a dynamic ID included in a received data frame, based on a verification dynamic ID that is generated in advance using a method identical to that of the dynamic ID before a data frame is received from each additional device.

In accordance with another aspect of the present invention to accomplish the above objects, there is provided a method for generating and operating a dynamic CAN ID, including generating a priority ID that is a base ID; generating a dynamic ID that is dynamically changed; and transmitting/receiving a data frame in which a dynamic CAN ID including the priority ID and the dynamic ID is combined with data.

The method may further include, when a data frame is received from an additional device, generating a verification dynamic ID using a method identical to that of the dynamic ID, and verifying a dynamic ID included in the received data frame using the verification dynamic ID.

The priority ID may be maintained at a fixed value rather than being dynamically changed.

Generating the priority ID may be configured to generate a priority ID to which a number of bits sufficient to represent a total number of devices belonging to an identical sub-network are allocated.

The priority ID may not overlap priority IDs corresponding to additional devices belonging to the identical sub-network.

Generating the dynamic ID may be configured to generate the dynamic ID such that a sum of a number of bits of the dynamic ID and a number of bits of the priority ID becomes a preset number of bits of a CAN ID.

The method may further include generating a one-time key required to generate a hash value to be used in a Hash-based Message Authentication Code (HMAC), wherein generating the dynamic ID may be configured to generate the dynamic ID using the one-time key.

Generating the one-time key may be configured to generate a new one-time key using one or more of previously generated one-time keys.

Verifying the dynamic ID may be configured to verify a dynamic ID included in a received data frame, based on a verification dynamic ID that is generated in advance using a method identical to that of the dynamic ID before a data frame is received from each additional device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a system for generating and operating a dynamic CAN ID according to an embodiment of the present invention;

FIG. 2 is a flow diagram illustrating a procedure for generating and operating a dynamic CAN ID according to an embodiment of the present invention;

FIG. 3 is a flow diagram illustrating an example of the mutual authentication and session key distribution procedure illustrated in FIG. 2;

FIG. 4 is a block diagram illustrating an embodiment of the apparatus for generating and operating a dynamic CAN ID, illustrated in FIG. 1;

FIG. 5 is a diagram illustrating a comparison between a conventional CAN ID and an example of a CAN ID generated according to an embodiment of the present invention;

FIG. 6 is a diagram illustrating examples of a dynamic CAN ID generated according to an embodiment of the present invention;

FIG. 7 is an operation flowchart illustrating a method for generating and operating a dynamic CAN ID according to an embodiment of the present invention;

FIG. 8 is a flow diagram illustrating a data frame transmission/reception procedure between apparatuses for generating and operating a dynamic CAN ID according to an embodiment of the present invention; and

FIG. 9 is an embodiment of the present invention implemented in a computer system.

### DESCRIPTION OF THE PREFERRED EMBODIMENTS

The present invention may be variously changed, and may have various embodiments, and specific embodiments will be described in detail below with reference to the attached drawings. The advantages and features of the present invention and methods for achieving them will be more clearly understood from the following detailed description taken in conjunction with the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

However, the present invention is not limited to the following embodiments, and some or all of the following embodiments can be selectively combined and configured so that various modifications are possible. In the following embodiments, terms such as “first” and “second” are not intended to restrict the meanings of components, and are merely intended to distinguish one component from other components. A singular expression includes a plural expression unless a description to the contrary is specifically pointed out in context. In the present specification, it should be understood that terms such as “include” or “have” are merely intended to indicate that features or components described in the present specification are present, and are not intended to exclude the possibility that one or more other features or components will be present or added.

Embodiments of the present invention will be described in detail with reference to the accompanying drawings. In the following description of the present invention, the same reference numerals are used to designate the same or similar elements throughout the drawings, and repeated descriptions of the same components will be omitted.

Embodiments of the present invention are intended to improve security by increasing expenses required for attack activities using a Moving Target Defense (MTD) strategy. Here, the term “MTD” denotes defensive technology for dynamically changing components of an important system so as to protect the important system from cyber attacks. Defensive technologies prior to the development of MTD use static settings (e.g., Internet Protocol (IP), port, names, software stacks, networks, and configuration parameters). Static settings provide a lot of time and information to attackers. In this way, due to an asymmetric condition in which an attacker is in an advantageous position, it is very difficult to completely defend an important system. In order to reverse such an asymmetric offensive/defensive relationship, MTD technology has been defined. MTD is active security technology for reversing an asymmetric condition between an attacker and an important system.

Embodiments of the present invention are intended to provide a dynamic CAN ID generation and operation method in which only legitimate ECUs can participate in communication by dynamically changing CAN IDs used by Electronic Control Units (ECUs) in a Controller Area Network (CAN). Only legitimate ECUs belonging to a specific sub-network may simultaneously provide a data frame authentication function and an ECU authentication function by synchronizing dynamic CAN IDs which are mutually changed. In contrast, there is a difference in that, in a general transport means (e.g. a vehicle) environment, a previously allocated CAN ID is not changed.

Here, the transport means may include a vehicle, a ship, an airplane, other transport means, etc.

The following Table 1 shows a description of the notation used in the present invention. Here, a gateway ECU may be a trusted party.

TABLE 1

| | |
|---|---|
| DID | Dynamic ID |
| BID | Base ID |
| GECU | Gateway ECU |
| ECU_i_j | i-th ECU belonging to sub-network j |
| CTR_i_j | Data frame transmission counter of ECU_i_j |
| DID_i_j_k_c | Dynamic ID used when ECU_i_j transmits c-th data |
| | frame in k-th session (c is identical to CTR_i_j) |
| K_i_j | Symmetric key shared between GECU and ECU_i_j |
| | (authentication key used in session key distribution |
| | procedure) |
| KGK_j | Symmetric key shared between ECUs belonging to sub- |
| | network j and GECU (key generation key used in session |
| | key distribution procedure) |
| GSK_j_k | Group session key used by ECUs belonging to sub- |
| | network j in k-th session |
| OTK_j_k_c | One-time key used to generate DID_i_j_k_c when |
| | ECUs belonging to sub-network j transmit c-th data |
| | frame in k-th session |
| Seed_j_k | Value used when ECUs belonging to sub-network j |
| | generate GSK_j_k in k-th session |
| R_i_j | Random number generated by ECU_i_j |
| α_j | Total number of ECUs belonging to sub-network j |
| Hₓ( ) | Unidirectional hash function using x as key |
| | H_{X}: {0,1}* □ key -> {0,1}¹²⁸ |
| KDFₓ( ) | Key generation function using x as key |

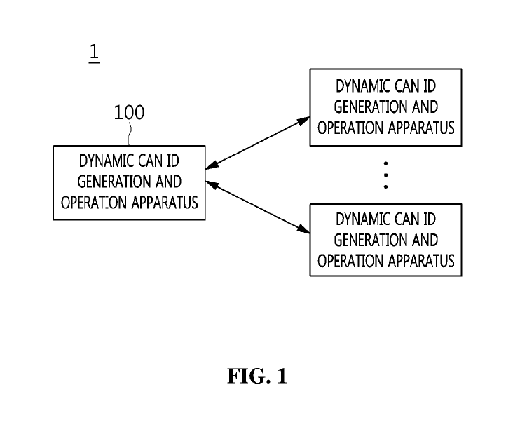

FIG. 1 is a diagram illustrating the configuration of a system 1 for generating and operating a dynamic CAN ID (hereinafter also referred to as a “dynamic CAN ID generation and operation system 1”) according to an embodiment of the present invention.

Referring to FIG. 1, in the dynamic CAN ID generation and operation system 1 according to the embodiment of the present invention, a plurality of apparatuses 100 for generating and operating a dynamic CAN ID (hereinafter also referred to as “dynamic CAN ID generation and operation apparatuses 100”) may be connected to each other.

Each of the dynamic CAN ID generation and operation apparatuses 100 according to the embodiment of the present invention is characterized in that it generates a priority ID corresponding to the base ID of the corresponding dynamic CAN ID generation and operation apparatus 100, generates a dynamic ID that is dynamically changed, and transmits/receives a data frame in which a CAN ID composed of the priority ID and the dynamic ID is combined with data, in order to perform secure communication with additional devices which are connected to each other and belong to the same sub-network.

In a selective embodiment, when a data frame is received from an additional device, the corresponding dynamic CAN ID generation and operation apparatus 100 may generate a verification dynamic ID through a dynamic ID generation unit, and may verify a dynamic ID included in the received data frame using the verification dynamic ID.

That is, the dynamic CAN ID generation and operation apparatuses 100 belonging to the same sub-network may generate dynamic IDs using the same method therebetween, and may verify received dynamic IDs by comparing the dynamic IDs, generated using the same method, with the received dynamic IDs.

In a selective embodiment, a priority ID generated by each dynamic CAN ID generation and operation apparatus 100 may be maintained at a fixed value rather than being dynamically changed.

That is, this may mean that the predefined priority of a data frame will not be subsequently changed. A CAN may transmit a data frame using a Carrier Sense Multiple Access with Collision Avoidance (CSMA/CA) technique. At this time, the node having the lowest CAN ID bit value may acquire transmission priority. Therefore, priorities of data frames may not be changed by preventing priority IDs from being changed.

In a selective embodiment, when generating a priority ID, the dynamic CAN ID generation and operation apparatus 100 may set, based on the number of devices belonging to the same sub-network as the dynamic CAN ID generation and operation apparatus 100, the length of the number of bits that prevents an overlap from occurring between priority IDs corresponding to the devices as the minimum length of the priority ID.

For example, when the total number of devices belonging to the same sub-network as the dynamic CAN ID generation and operation apparatus 100 is 5, priority IDs may be generated by setting a length of three bits, which can represent five numbers, as the minimum length so that an overlap does not occur between priority IDs corresponding to the five devices. Therefore, in this case, the priority IDs may be designated to have a length of three or more bits.

Here, the minimum length of a priority ID may be set to the number of bits that can represent a number obtained by adding the total number of devices belonging to the same sub-network to the number of gateway ECUs.

In a selective embodiment, the priority ID generated by the dynamic CAN ID generation and operation apparatus 100 may not overlap priority IDs corresponding to additional devices belonging to the same sub-network as the corresponding dynamic CAN ID generation and operation apparatus 100.

That is, the devices belonging to the same sub-network may have their own unique priority IDs.

Here, each dynamic CAN ID generation and operation apparatus 100 may generate a truncated Hash-based Message Authentication Code (HMAC) when generating a dynamic CAN ID. In this case, there may occur a collision problem in which the same output value is formed due to the characteristics of a hash function. Therefore, each dynamic CAN ID generation and operation apparatus 100 may generate its own unique priority ID. As a result, even if different dynamic CAN ID generation and operation apparatuses 100 simultaneously generate and use the same dynamic CAN ID, priority IDs are unique in the same sub-network, and thus the avoidance of a collision between CAN IDs may be guaranteed.

In a selective embodiment, when generating a dynamic ID, each dynamic CAN ID generation and operation apparatus 100 may set the length of the dynamic ID to the number of bits obtained by subtracting the number of bits corresponding to a priority ID from the preset number of bits of a CAN ID.

For example, when the preset number of bits of a CAN ID is 29 and a priority ID has 4 bits, the dynamic CAN ID generation and operation apparatus 100 may set the length of the dynamic ID to 25 bits.

In a selective embodiment, the dynamic CAN ID generation and operation apparatus 100 may generate a one-time key to generate a hash value to be used in the HMAC, and may generate a dynamic ID using the one-time key.

Here, when generating a one-time key, the dynamic CAN ID generation and operation apparatus 100 may use one or more of the number of a current session, the number of a current data frame, and a group session key.

In a selective embodiment, when generating a one-time key, the dynamic CAN ID generation and operation apparatus 100 may generate a new one-time key using one or more of one-time keys that were previously generated.

For example, the dynamic CAN ID generation and operation apparatus 100 may generate a new one-time key using the most recently generated one-time key.

In a selective embodiment, when verifying a dynamic ID included in a received data frame, the dynamic CAN ID generation and operation apparatus 100 may generate a verification dynamic ID in advance before receiving a data frame from each additional device, and may perform verification based on the verification dynamic ID generated in advance.

That is, by generating the verification dynamic ID in advance, the time required to verify the dynamic ID when a data frame is received may be shortened.

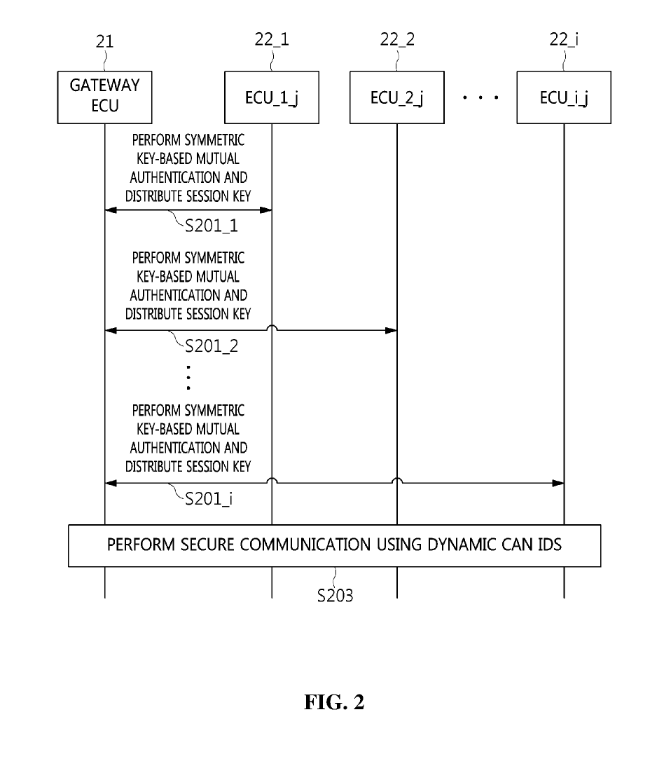

FIG. 2 is a flow diagram illustrating a procedure for generating and operating a dynamic CAN ID according to an embodiment of the present invention.

FIG. 2 illustrates an example of the procedure for generating and operating dynamic CAN IDs for ECUs belonging to sub-network j.

However, among descriptions made here, a procedure for authenticating ECUs and distributing session keys is only an example that can be used in technology for generating and operating dynamic CAN IDs, which is the target of the present invention, and thus other procedures or methods may also be used.

Referring to FIG. 2, the procedure for generating and operating dynamic CAN IDs according to the embodiment of the present invention performs ECU authentication between a gateway ECU (GECU) 21 and ECU devices 22_1 to 22_i belonging to sub-network j and distributes session keys therebetween.

In detail, the gateway ECU 21 and the ECU_1_j_22_1 corresponding to a first ECU of the sub-network j perform symmetric key-based mutual authentication and distribute a session key therebetween at step S201_1.

Further, the gateway ECU 21 and the ECU_2_j_22_2 corresponding to a second ECU of the sub-network j perform symmetric key-based mutual authentication and distribute a session key therebetween at step S201_2.

Through the repetition of the above-described mutual authentication and session key distribution procedure, the gateway ECU 21 and the ECU_i_j_22_i corresponding to the last ECU of the sub-network j perform symmetric key-based mutual authentication and distribute a session key therebetween at step S201_i.

After the mutual authentication and session key distribution steps S201_1 to S201_i have been performed, respective ECUs 22_1 to 22_i perform secure communication using dynamic CAN IDs at step S203.

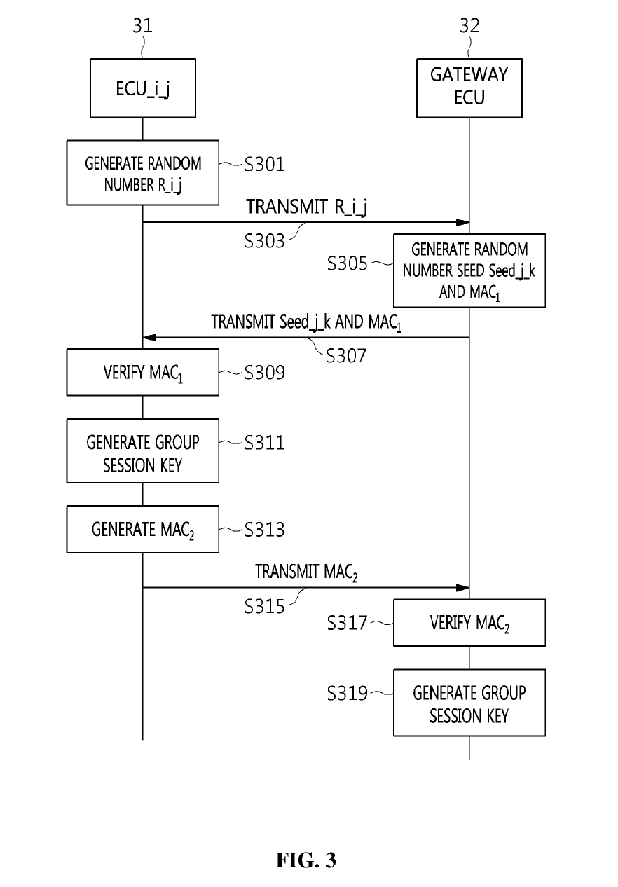

FIG. 3 is a flow diagram illustrating an example of the mutual authentication and session key distribution procedure (step S201_i) illustrated in FIG. 2.

FIG. 3 illustrates an example of the mutual authentication and session key distribution procedure between ECUs, included in sub-network j, and the gateway ECU, illustrated in FIG. 2, wherein this step is an advance preparation step for generating and operating a dynamic CAN ID. In a typical IT environment, an authentication technique in use (based on a certificate or not based on a certificate) and a key distribution technique may be used. In FIG. 3, a symmetric key-based mutual authentication and key distribution technique is illustrated as an example.

Referring to FIG. 3, Authenticated Key Exchange Protocol 2 (AKEP2) may be used for ECU authentication and session key distribution.

AKEP2 provides a mutual authentication and session key distribution function. ECUs belonging to the same sub-network execute AKEP2 in a defined order. When a specific ECU executes AKEP2 with the gateway ECU, the remaining ECUs wait their turns without participating in communication. Further, such a protocol execution procedure is implemented as a 3-way handshake, as illustrated in FIG. 3.

In detail, in the mutual authentication and session key distribution procedure, an ECU_i_j 31, which is an i-th ECU belonging to sub-network j, generates a random number R_i_j at step S301.

Next, in the mutual authentication and session key distribution procedure, the ECU_i_j 31 transmits the random number R_i_j to a gateway ECU 32 at step S303.

Then, in the mutual authentication and session key distribution procedure, the gateway ECU 32 generates a random number seed Seed_j_k and Message Authentication Code 1 (MAC₁) at step S305.

Here, the MAC₁ may be generated using a hash function, the random number R_i_j, and the random number seed Seed_j_k together.

For example, the MAC₁ may be calculated using the following Equation (1):

MAC₁=H_{K}_{_}ᵢ_{_}ⱼ(ECU_i_j,GECU,R_i_j,Seed_j_k) (1)

Further, in the mutual authentication and session key distribution procedure, the gateway ECU (GECU) 32 transmits the random number seed Seed_j_k and the MAC₁ to the ECU_i_j 31 at step S307.

Next, in the mutual authentication and session key distribution procedure, the ECU_i_j 31 generates MAC₁ using the same method as the gateway ECU (GECU) 32 and verifies the MAC₁ received from the gateway ECU (GECU) 32 by comparing the generated MAC₁ with the received MAC₁ at step S309.

For example, the ECU_i_j 31 may also verify the received MAC₁ by calculating MAC₁ using both the random number R_i_j, generated by the ECU_i_j 31, and the random number seed Seed_j_k, received from the gateway ECU 32, as shown in Equation (1).

Then, in the mutual authentication and session key distribution procedure, the ECU_i_j 31 generates a group session key GSK_j_k using a key generation function at step S311.

For example, the group session key GSK_j_k may be calculated as given by the following Equation (2):

GSK_j_k=KDF_{KGK}_{_}ⱼ(Seed_j_k) (2)

Further, in the mutual authentication and session key distribution procedure, the ECU_i_j 31 generates MAC₂ at step S313.

Here, the MAC₂ may be calculated using the random number seed Seed_j_k.

For example, the MAC₂ may be calculated as given by the following Equation (3):

MAC₂=H_{K}_{_}ᵢ_{_}ⱼ(ECU_i_j,Seed_j_k) (3)

Next, in the mutual authentication and session key distribution procedure, the ECU_i_j 31 transmits the MAC₂ to the gateway ECU 32 at step S315.

Further, in the mutual authentication and session key distribution procedure, the gateway ECU 32 generates MAC₂ using the same method as the ECU_i_j_31, and verifies the MAC₂ received from the ECU_i_j_31 by comparing the generated MAC₂ with the received MAC₂ at step S317.

For example, the gateway ECU 32 may verify the received MAC₂ by calculating MAC₂ using the random number seed Seed_j_k, generated by the gateway ECU 32, as shown in Equation (3).

Furthermore, in the mutual authentication and session key distribution procedure, the ECU_i_j 31 generates a group session key GSK_j_k using a key generation function at step S319.

For example, the group session key GSK_j_k may be calculated using Equation (2).

The ECU_i_j 31 and the gateway ECU 32 may perform ECU authentication and session key distribution while performing a 3-way handshake through the above steps S301 to S319. When the 3-way handshake procedure is normally terminated, all ECUs belonging to the sub-network j secure the same session key GSK_j_k. The GSK_j_k is used later to generate a one-time key.

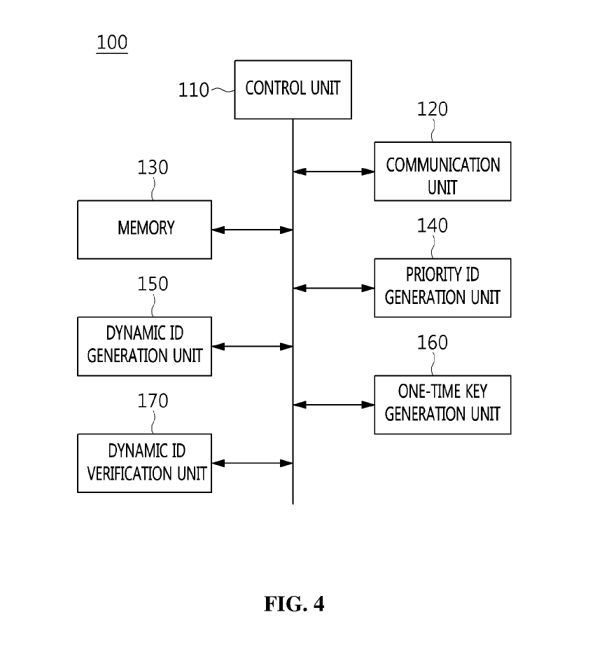

FIG. 4 is a block diagram illustrating an example of the dynamic CAN ID generation and operation apparatus 100 illustrated in FIG. 1.

Referring to FIG. 4, the dynamic CAN ID generation and operation apparatus 100 according to an embodiment of the present invention includes a control unit 110, a communication unit 120, memory 130, a priority ID generation unit 140, a dynamic ID generation unit 150, a one-time key generation unit 160, and a dynamic ID verification unit 170.

In detail, the control unit 110, which is a kind of central processing unit, controls the overall operation of a process for generating and operating a dynamic CAN ID. That is, the control unit 110 may communicate with additional devices by controlling the communication unit 120, and may provide various functions by controlling the priority ID generation unit 140, the dynamic ID generation unit 150, the one-time key generation unit 160, and the dynamic ID verification unit 170.

Here, the control unit 110 may include all types of devices capable of processing data, such as a processor. Here, the term “processor” may refer to a data-processing device that has a circuit physically structured to perform functions represented by code or instructions included in a program and that is embedded in hardware. In this way, examples of the data-processing device embedded in hardware may include, but are not limited to, processing devices such as a microprocessor, a Central Processing Unit (CPU), a processor core, a multiprocessor, an Application-Specific Integrated Circuit (ASIC), and a Field-Programmable Gate Array (FPGA).

The communication unit 120 provides a communication interface required for the transfer of transmission/reception signals between individual dynamic CAN ID generation and operation apparatuses 100.

Here, the communication unit 120 may be a device that includes hardware and software needed to transmit and receive signals, such as control signals or data signals, through wired/wireless connection to additional network devices.

The memory 130 performs a function of temporarily or permanently storing data processed by the control unit 110. Here, the memory 130 may include, but is not limited to, magnetic storage media or flash storage media.

The priority ID generation unit 140 generates a priority ID, which is the base ID of the dynamic CAN ID generation and operation apparatus 100.

Here, the priority ID may be maintained at a fixed value rather than being dynamically changed.

That is, this may mean that the previously defined priority of a data frame is not subsequently changed. A CAN may transmit data frames using a CSMA/CA technique. In this case, the node having the lowest CAN ID bit value may acquire transmission priority. Therefore, the priority of the corresponding data frame may not be changed by preventing the priority ID from being changed.

In this case, when generating a priority ID, the priority ID generation unit 140 may set, based on the number of devices belonging to the same sub-network as the dynamic CAN ID generation and operation apparatus 100, the length of the number of bits that prevents an overlap from occurring between priority IDs corresponding to the devices as the minimum length of the priority ID.

That is, when the number of ECUs belonging to the same sub-network is a, n indicating the minimum number of bits of the priority ID may be set to a natural number satisfying the following Equation (4):

2ⁿ⁻¹<α≤2ⁿ (4)

For example, when the total number of devices belonging to the same sub-network as the dynamic CAN ID generation and operation apparatus 100 is 5, priority IDs may be generated by setting a length of three bits, which can represent five numbers, as the minimum length so that an overlap does not occur between priority IDs corresponding to the five devices. Therefore, in this case, the priority IDs may be designated to have a length of three or more bits.

Here, the priority ID generation unit 140 may generate a priority ID by setting the minimum length of the priority ID to the number of bits that can represent a number obtained by adding the total number of devices belonging to the same sub-network as the dynamic CAN ID generation and operation apparatus 100 to the number of gateway ECUs.

That is, when the number of ECUs belonging to the same sub-network is a, and the number of gateway ECUs is 1, n indicating the minimum number of bits of the priority ID may be set to a natural number satisfying the following Equation (5):

2ⁿ⁻¹≤α<2ⁿ (5)

Here, the priority ID generation unit 140 may generate a priority ID so that the priority ID does not overlap priority IDs corresponding to additional devices belonging to the same sub-network.

That is, the devices belonging to the same sub-network may have their own unique priority IDs.

The dynamic ID generation unit 150 generates a dynamic ID that is dynamically changed.

Here, the dynamic ID generation unit 150 may generate the dynamic ID before the dynamic CAN ID generation and operation apparatus 100 transmits a data frame.

Here, when generating a dynamic ID, the dynamic ID generation unit 150 may set the length of the dynamic ID to the number of bits obtained by subtracting the number of bits corresponding to the priority ID from the preset number of bits of a CAN ID.

For example, when the preset number of bits of a CAN ID is 29 and the priority ID has 4 bits, the dynamic ID generation unit 150 may generate the dynamic ID so that the dynamic ID has a length of 25 bits. In this case, since the maximum size of the dynamic ID is less than 29 bits, a truncated HMAC can be used. Because the truncated HMAC may be vulnerable to collision attacks, a one-time key-based HMAC may be used so as to guarantee security. The one-time key may be generated using a HMAC-based One-Time Password (HOTP).

Here, the dynamic ID generation unit 150 may generate the dynamic ID using a one-time key generated by the one-time key generation unit 160.

The one-time key generation unit 160 generates a one-time key required so as to generate a hash value to be used in the HMAC.

Here, when generating a one-time key, the one-time key generation unit 160 may use one or more of the number of a current session, the number of a current data frame, and a group session key.

Here, when generating a one-time key, the one-time key generation unit 160 may generate a new one-time key using one or more of one-time keys that were previously generated.

For example, the one-time key generation unit 160 may generate a new one-time key using the most recently generated one-time key.

When a data frame is received from an additional device, the dynamic ID verification unit 170 may generate a verification dynamic ID through the dynamic ID generation unit, and may verify a dynamic ID included in the received data frame using the verification dynamic ID.

That is, the dynamic CAN ID generation and operation apparatuses 100 belonging to the same sub-network may generate dynamic IDs using the same method therebetween, and may verify received dynamic IDs by comparing the dynamic IDs, generated using the same method, with the received dynamic IDs.

When verifying the dynamic ID included in the received data frame, the dynamic ID verification unit 170 may generate a verification dynamic ID in advance before receiving the data frame from the additional device, and may perform verification based on the verification dynamic ID generated in advance.

In other words, by generating the verification dynamic ID in advance, the time required to verify the dynamic ID when a data frame is received may be shortened.

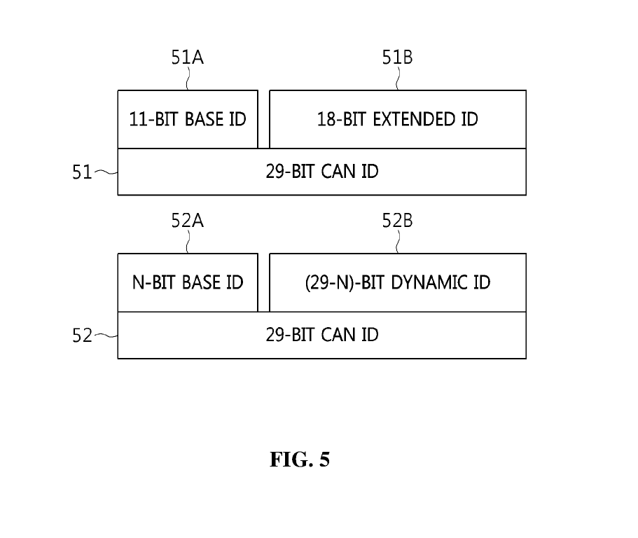

FIG. 5 is a diagram illustrating a comparison between a conventional CAN ID and an example of a CAN ID generated according to an embodiment of the present invention.

In FIG. 5, a conventional 29-bit CAN ID 51 and a 29-bit CAN ID 52 generated according to the embodiment of the present invention are illustrated.

Referring to FIG. 5, the conventional 29-bit CAN ID 51 is composed of an 11-bit base ID 51A and an 18-bit extended ID 51B.

However, the 29-bit CAN ID 52 generated according to the embodiment of the present invention is composed of an n-bit base ID 52A and a (29-n)-bit dynamic ID 52B.

Here, the number of bits for the base ID 52A may be set first, and the dynamic ID 52B may then be set such that the total number of bits of the base ID 52A and the dynamic ID 52B is 29.

The base ID 52A may be a priority ID.

Here, the n bits allocated to the base ID 52A may be set to a size that prevents a collision from occurring between priority IDs corresponding to ECUs included in the same sub-network, as described above.

For example, when a total of five ECUs are included in the sub-network to which the dynamic CAN ID generation and operation apparatus 100 belongs, the base ID 52A may be allocated to have a length of three or more bits, which can represent five numbers.

Here, once the priority ID is defined, it is not changed, and only the dynamic ID is continuously changed.

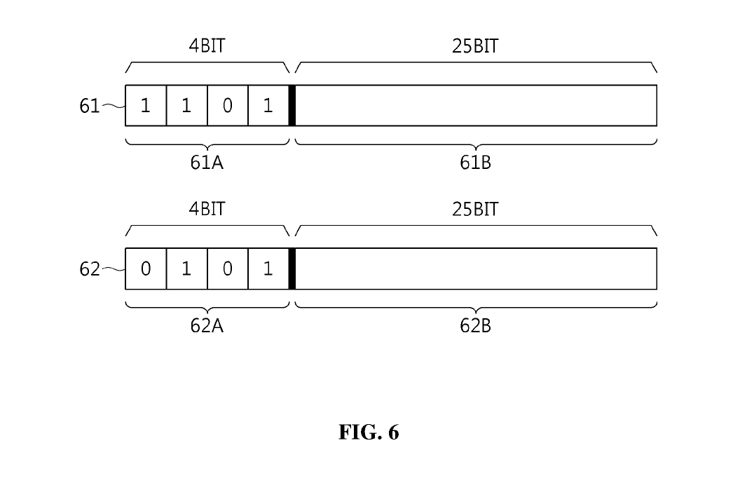

FIG. 6 is a diagram illustrating examples of a dynamic CAN ID generated according to an embodiment of the present invention.

In FIG. 6, an example 61 of a dynamic CAN ID generated in a thirteenth ECU belonging to sub-network j and an example 62 of a dynamic CAN ID generated in a fifth ECU belonging to sub-network j are illustrated.

Here, it is assumed that 15 or fewer ECUs belong to the sub-network j. Unique priority IDs may be allocated to all ECUs belonging to the sub-network j using only a minimum of 4 bits.

The priority ID 61A of the example 61 of the dynamic CAN ID generated in the thirteenth ECU belonging to the sub-network j may be set to 13, which is a 4-bit binary number of 1101₍₂₎, and the dynamic ID 61B may be allocated to the remaining 25 bits.

The priority ID 62A of the example 62 of the dynamic CAN ID generated in the fifth ECU belonging to the sub-network j may be set to 5, which is a 4-bit binary value of 0101₍₂₎, and the dynamic ID 62B may be allocated to the remaining 25 bits.

In this way, in the embodiment of the present invention, priority IDs of respective ECUs are unique and fixed, and thus a function of preventing a collision between CAN IDs from occurring may be provided, and the priorities of data frames may not be influenced.

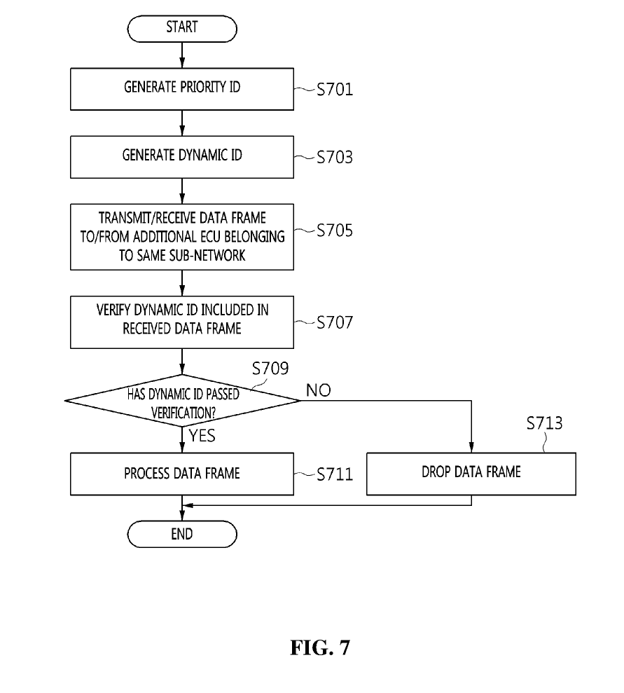

FIG. 7 is an operation flowchart illustrating a method for generating and operating a dynamic CAN ID (hereinafter also referred to as a “dynamic CAN ID generation and operation method”) according to an embodiment of the present invention.

Referring to FIG. 7, in the dynamic CAN ID generation and operation method according to the embodiment of the present invention, the dynamic CAN ID generation and operation apparatus (see 100 of FIG. 1) generates a priority ID, which is the base ID of a dynamic CAN ID, at step S701.

The priority ID may be maintained at a fixed value rather than being dynamically changed.

Here, based on the number of devices belonging to the same sub-network, the length of the number of bits that prevents an overlap from occurring between priority IDs corresponding to the devices may be set as the minimum length of the priority ID when the priority ID is generated.

The priority ID may be generated by setting the minimum length of the priority ID to the number of bits that can represent a number obtained by adding the total number of devices belonging to the same sub-network to the number of gateway ECUs.

The priority ID may be generated such that it does not overlap priority IDs corresponding to additional devices belonging to the same sub-network.

Further, in the dynamic CAN ID generation and operation method according to the embodiment of the present invention, the dynamic CAN ID generation and operation apparatus (see 100 of FIG. 1) generates a dynamic ID, which is dynamically changed, at step S703.

Here, when the dynamic ID is generated, the length of the dynamic ID may be set to the number of bits obtained by subtracting the number of bits corresponding to the priority ID from the preset number of bits of a CAN ID.

Further, when a dynamic ID is generated, the dynamic ID may be generated using a one-time key.

The one-time key may be a key required to generate a hash value to be used in an HMAC.

The one-time key may be generated using one or more of the number of a current session, the number of a current data frame, and a group session key.

Here, a new one-time key may be generated using one or more of one-time keys that were previously generated.

For example, a new one-time key may be generated using the most recently generated one-time key.

Next, in the dynamic CAN ID generation and operation method according to the embodiment of the present invention, the dynamic CAN ID generation and operation apparatus (see 100 of FIG. 1) transmits/receives a data frame, including both the dynamic ID and data, to/from an additional ECU belonging to the same sub-network at step S705.

That is, each data frame may include a priority ID, a dynamic ID, and data.

Further, in the dynamic CAN ID generation and operation method according to the embodiment of the present invention, the dynamic CAN ID generation and operation apparatus (see 100 of FIG. 1) verifies a dynamic ID included in the received data frame at step S707.

At this time, a verification dynamic ID may be generated using the same method as that of step S703, and the dynamic ID included in the received data frame may be verified using the verification dynamic ID.

When the dynamic ID included in the received data frame is verified, the verification dynamic ID may be generated in advance before the corresponding data frame is received from the additional device, and verification may be performed based on the verification dynamic ID generated in advance.

Next, in the dynamic CAN ID generation and operation method according to the embodiment of the present invention, the dynamic CAN ID generation and operation apparatus (see 100 of FIG. 1) determines whether the dynamic ID included in the received data frame has passed the verification at step S709.

Here, whether the dynamic ID has passed the verification may be determined by checking whether the generated verification dynamic ID is identical to the dynamic ID included in the received data frame.

If it is determined at step S709 that the dynamic ID has passed the verification, the received data frame is processed at step S711.

If it is determined at step S709 that the dynamic ID has not passed the verification, the received data frame is dropped at step S713.

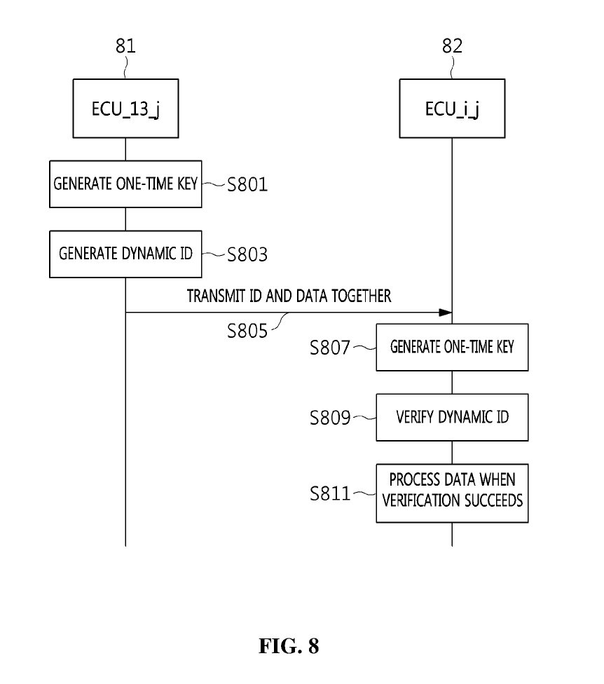

FIG. 8 is a flow diagram illustrating a data frame transmission/reception procedure between dynamic CAN ID generation and operation apparatuses (see 100 of FIG. 1) according to an embodiment of the present invention.

In detail, FIG. 8 illustrates the procedure in which ECU_13_j 81 (i.e. a transmission ECU) belonging to sub-network j transmits a data frame to ECU_i_j 82 (i.e. a reception ECU) belonging to the sub-network j.

Referring to FIG. 8, in the data frame transmission/reception procedure according to the embodiment of the present invention, the transmission ECU 81 generates a one-time key to be used to generate a dynamic ID using a group session key, as given by the following Equation (6) at step S801.

OTK_j_k_c=H_{GSK}_{_}ⱼ_{_}ₖ(OTK_j_k_(c−1),CTR_i_j) (6)

For example, in the situation in which an eighth data frame is transmitted in a k-th session, the transmission ECU 81 may generate a one-time key OTK_j_k_8 to be used to transmit the eighth data frame using a group session key GSK_j_k, as given by the following Equation (7):

OTK_j_k_8=H_{GSK}_{_}ⱼ_{_}ₖ(OTK_j_k_7,CTR_13_j) (7)

Next, in the data frame transmission/reception procedure according to the embodiment of the present invention, the transmission ECU 81 generates a dynamic ID using the one-time key, as given by the following Equation (8), at step S803.

DID_i_j_k_c=H_{OTK}_{_}ⱼ_{_}ₖ_{_}_{c}(DID_i_j_k_(c−1),CTR_i_j) (8)

For example, in the situation in which the eighth data frame is transmitted in the k-th session, the transmission ECU 81 may generate a dynamic ID DID_13_j_k_8 using the one-time key OTK_j_k_8, as given by the following Equation (9):

DID_13_j_k_8=H_{OTK}_{_}ⱼ_{_}ₖ_{_}_{c}(DID_13_j_k_7,CTR_13_j) (9)

Further, in the data frame transmission/reception procedure according to the embodiment of the present invention, the transmission ECU 81 transmits a data frame composed of a priority ID, the dynamic ID, and a data field to the reception ECU 82 at step S805.

Furthermore, in the data frame transmission/reception procedure according to the embodiment of the present invention, the reception ECU 82 generates a verification one-time key that is to be used to generate a dynamic ID using a group session key, as represented by Equation (6), in order to verify the received data frame at step S807.

For example, in the situation in which the eighth data frame is transmitted in the k-th session, the reception ECU 82 may generate a verification one-time key OTK_j_k_8 using the group session key GSK_j_k, as represented by Equation (7), in order to verify the received data frame.

Next, in the data frame transmission/reception procedure according to the embodiment of the present invention, the reception ECU 82 generates a verification dynamic ID using the one-time key, as represented by Equation (8), in order to verify the received data frame, and then verifies the received data frame by comparing the verification dynamic ID with the dynamic ID included in the received data frame at step S809.

For example, in the situation in which the eighth data frame is transmitted in the k-th session, the reception ECU 82 may generate a verification dynamic ID DID_13_j_k_8 using the one-time key OTK_j_k_8, as represented by Equation (9), and may then verify the received data frame by comparing the verification dynamic ID with the dynamic ID included in the received data frame.

Furthermore, in the data frame transmission/reception procedure according to the embodiment of the present invention, the reception ECU 82 may process the received data frame when verification of the received data frame succeeds at step S811.

Conversely, the reception ECU may drop the received data frame when verification of the received data frame fails.

The above-described embodiments may be implemented as a program that can be executed by various computer means. In this case, the program may be recorded on a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as Compact Disk Read-Only Memory (CD-ROM) and a Digital Versatile Disk (DVD), magneto-optical media, such as a floptical disk, ROM, Random Access Memory (RAM), and flash memory. Examples of the program instructions include machine language code, such as code created by a compiler, and high-level language code executable by a computer using an interpreter. The hardware devices may be configured to operate as one or more software modules in order to perform the operation of the present invention, and vice versa.

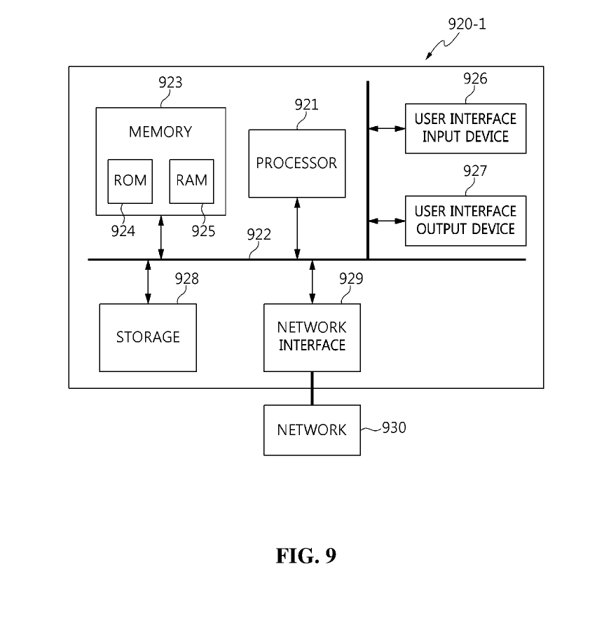

An embodiment of the present invention may be implemented in a computer system, e.g., as a computer readable medium. As shown in in FIG. 9, a computer system 920-1 may include one or more of a processor 921, a memory 923, a user interface input device 926, a user interface output device 927, and a storage 928, each of which communicates through a bus 922. The computer system 920-1 may also include a network interface 929 that is coupled to a network 930. The processor 921 may be a central processing unit (CPU) or a semiconductor device that executes processing instructions stored in the memory 923 and/or the storage 928. The memory 923 and the storage 928 may include various forms of volatile or non-volatile storage media. For example, the memory may include a read-only memory (ROM) 924 and a random access memory (RAM) 925.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

Specific executions, described in the present invention, are only embodiments, and are not intended to limit the scope of the present invention using any methods. For the simplification of the present specification, a description of conventional electronic components, control systems, software, and other functional aspects of the systems may be omitted. Further, connections of lines between components shown in the drawings or connecting elements therefor illustratively show functional connections and/or physical or circuit connections. In actual devices, the connections may be represented by replaceable or additional various functional connections, physical connections or circuit connections. Further, unless a definite expression, such as “essential” or “importantly” is specifically used in context, the corresponding component may not be an essential component for the application of the present invention.

In accordance with the present invention, by means of the apparatus and method for generating and operating a dynamic CAN ID, a Moving Target Defense (MTD) strategy which dynamically changes CAN IDs is used, and thus expenses required for attack activities by an attacker may be increased.

Further, in accordance with the present invention, by means of the apparatus and method for generating and operating a dynamic CAN ID, an authentication function and a communication message authentication function between legitimate ECUs belonging to a specific sub-network may be provided in a CAN environment constructed within a transport means.

As described above, the spirit of the present invention should not be defined by the above-described embodiments, and it will be apparent that the accompanying claims and equivalents thereof are included in the scope of the spirit of the present invention.

What is claimed is:

1. An apparatus for generating and operating a dynamic Controller Area Network (CAN) identifier (ID), comprising:
a priority ID generation unit for generating a priority ID that is a base ID;
a dynamic ID generation unit for generating a dynamic ID that is dynamically changed; and
a communication unit for transmitting/receiving a data frame in which a dynamic CAN ID including the priority ID and the dynamic ID is combined with data.

2. The apparatus of claim 1, further comprising a dynamic ID verification unit for, when a data frame is received from an additional device, generating a verification dynamic ID using a method identical to that of the dynamic ID, and verifying a dynamic ID included in the received data frame using the verification dynamic ID.

3. The apparatus of claim 2, wherein the priority ID is maintained at a fixed value rather than being dynamically changed.

4. The apparatus of claim 3, wherein the priority ID generation unit generates a priority ID to which a number of bits sufficient to represent a total number of devices belonging to an identical sub-network are allocated.

5. The apparatus of claim 4, wherein the priority ID does not overlap priority IDs corresponding to additional devices belonging to the identical sub-network.

6. The apparatus of claim 5, wherein the dynamic ID generation unit generates the dynamic ID such that a sum of a number of bits of the dynamic ID and a number of bits of the priority ID becomes a preset number of bits of a CAN ID.

7. The apparatus of claim 6, further comprising a one-time key generation unit for generating a one-time key required to generate a hash value to be used in a Hash-based Message Authentication Code (HMAC),
wherein the dynamic ID generation unit is configured to generate the dynamic ID using the one-time key.

8. The apparatus of claim 7, wherein the one-time key generation unit generates a new one-time key using one or more of previously generated one-time keys.

9. The apparatus of claim 8, wherein the dynamic ID verification unit verifies a dynamic ID included in a received data frame, based on a verification dynamic ID that is generated in advance using a method identical to that of the dynamic ID before a data frame is received from each additional device.

10. A method for generating and operating a dynamic Controller Area Network (CAN) identifier (ID), comprising:
generating a priority ID that is a base ID;
generating a dynamic ID that is dynamically changed; and
transmitting/receiving a data frame in which a dynamic CAN ID including the priority ID and the dynamic ID is combined with data.

11. The method of claim 10, further comprising, when a data frame is received from an additional device, generating a verification dynamic ID using a method identical to that of the dynamic ID, and verifying a dynamic ID included in the received data frame using the verification dynamic ID.

12. The method of claim 11, wherein the priority ID is maintained at a fixed value rather than being dynamically changed.

13. The method of claim 12, wherein generating the priority ID is configured to generate a priority ID to which a number of bits sufficient to represent a total number of devices belonging to an identical sub-network are allocated.

14. The method of claim 13, wherein the priority ID does not overlap priority IDs corresponding to additional devices belonging to the identical sub-network.

15. The method of claim 14, wherein generating the dynamic ID is configured to generate the dynamic ID such that a sum of a number of bits of the dynamic ID and a number of bits of the priority ID becomes a preset number of bits of a CAN ID.

16. The method of claim 15, further comprising generating a one-time key required to generate a hash value to be used in a Hash-based Message Authentication Code (HMAC),
wherein generating the dynamic ID is configured to generate the dynamic ID using the one-time key.

17. The method of claim 16, wherein generating the one-time key is configured to generate a new one-time key using one or more of previously generated one-time keys.

18. The method of claim 17, wherein verifying the dynamic ID is configured to verify a dynamic ID included in a received data frame, based on a verification dynamic ID that is generated in advance using a method identical to that of the dynamic ID before a data frame is received from each additional device.
